(19) United States
(12) Patent Application Publication
(10) Pub. No.: US 2026/0234040 A1
(43) Pub. Date: Aug. 13, 2026

(54) SYSTEM AND METHOD FOR CONVERTING PLASTIC TO BIOLOGICALLY DEGRADABLE MATERIALS

(71) Applicant: Samuel Baker, Lake Mary, FL (US)

(72) Inventor: Samuel Baker, Lake Mary, FL (US)

(21) Appl. No.: 19/529,678

(22) Filed: Feb. 4, 2026

Related U.S. Application Data
(60) Provisional application No. 63/755,878, filed on Feb. 7, 2025.

(51) Int. Cl. C02F 3/28

(52) U.S. Cl. CPC C02F 3/28; C08L 2205/03

(57) ABSTRACT

A method of converting plastic to biologically degradable materials includes receiving plastic materials and preprocessing the received plastic to create a plurality of plastic ingots. The plastic ingots are fed into a pyrolysis vessel where they are heated and cooled. Vapors from the heating and cooling process are captured and cooled to create a polymer oil. The polymer oil is introduced into a bioreactor. Bacteria are slowly introduced to the bioreactor over a period of several days to several weeks. The bacteria consumes and digests the polymer oil within the bioreactor. Metabolites from the bacteria create a biodegradable suspension of plastic-free biomass that is harvested from the bioreactor. The harvested biomass is mixed with a gelling agent to create a solid puck of biodegradable, plastic-free, and shelf stable biogel for any number of different uses.

### CROSS-REFERENCE TO RELATED APPLICATIONS

This application claims the benefit of U.S. Application Ser. No. 63/755,878 filed on Feb. 7, 2025, the contents of which are incorporated herein by reference.

### TECHNICAL FIELD

The following disclosure contemplates various embodiments of a multi-step process for converting plastic waste into biodegradable and/or consumable materials.

### BACKGROUND

The statements in this section merely provide background information related to the present disclosure and may not constitute prior art.

Plastic products are cheap, lightweight, and durable, thus making them deeply integrated into modern life. To this end, many industries rely on plastic for items such as packaging, medical supplies, and other such products because alternatives can be more expensive or less practical. Although useful for these reasons, plastics are not environmentally friendly, and most recycling systems are inefficient or inconsistent, as many different types of plastics cannot be easily recycled, thus causing these items to end up in landfills and other locations.

Since the introduction of plastics into mainstream products, scientists have struggled to find ways to reduce or eliminate the long-lasting impacts of plastic waste products on the environment and human health. Because plastics are not biodegradable, they typically break down into ever smaller pieces (called microplastics) which can remain for hundreds of years in soil and water and ultimately end up in many living organisms.

Indeed, recent studies have found increasing amounts of microplastics throughout various oceans, wildlife, food, and even humans. This plastic waste harms ecosystems directly, as animals can become entangled in plastic or mistake it for food, often leading to injury or death.

Accordingly, it would be beneficial to provide a system and method for converting plastics to biologically degradable materials so as to overcome the drawbacks noted above.

### SUMMARY OF THE INVENTION

The present invention is directed to a method of converting plastic to biologically degradable materials. In one embodiment, the inventive method can include receiving any number of different types of plastic materials and preprocessing the received plastic to create a plurality of plastic ingots. In one embodiment, the plastic ingots can be fed into a pyrolysis vessel where they can be heated and cooled. Vapors from the heating and cooling process can be captured and cooled to create a polymer oil.

In one embodiment, the polymer oil can be introduced into a bioreactor. Bacteria can be slowly introduced over a period of several days to several weeks. The bacteria can consume and digest the polymer oil within the bioreactor. Metabolites from the bacteria consumption and digestion process form a biodegradable suspension of plastic-free biomass that can be harvested from the bioreactor. In one embodiment, the biomass can be mixed with a gelling agent such as gelatin to create a solid puck of biodegradable, plastic-free, and shelf-stable biogel for any number of different uses.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a process flowchart for converting plastics to biologically degradable materials according to a current embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described below, one embodiment of the inventive concept relates to a method for converting plastic waste into a biologically degradable material through a multi-step process that includes collection, preprocessing, liquefaction, microbial digestion, and conversion into bioavailable substrates for decomposer organisms. The process can accommodate various input materials, processing methods, and environmental conditions to optimize efficiency and output based on available technology and biological agents.

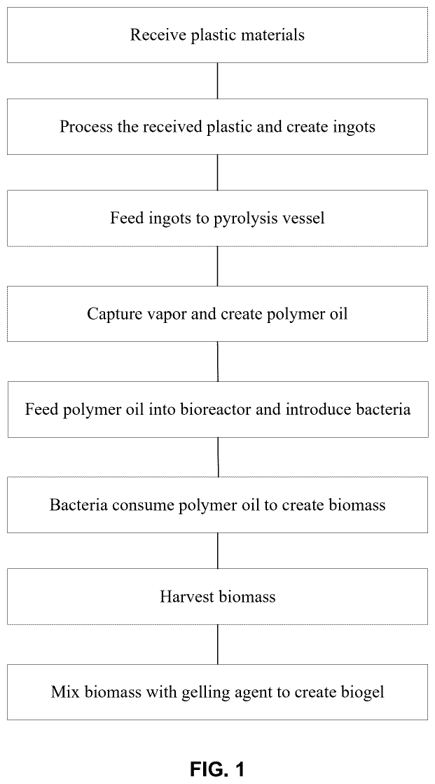

One embodiment of a method for converting plastic waste into a biologically degradable material can include the following steps, which are generally illustrated in the flowchart of FIG. 1. Other features of the current embodiments will become apparent in the course of the following descriptions, which are given for illustration of the current embodiments, and are not intended to be limiting thereof.

Step 1. Plastic Collection and Preprocessing. Any number of different types of plastic materials for use herein can received and/or sourced from any number of different locations. In the preferred embodiment, the plastic utilized by the inventive method can include, comprise, or consist of plastic waste material that would otherwise end up in landfills or other such locations. As such, several nonlimiting examples of plastic sourcing locations can include municipal waste streams, industrial byproducts, or direct consumer collection. In either instance, the plastic may be transported to a processing facility using vehicles such as trucks, vans, trains, or conveyor-based transport systems.

In the preferred embodiment, polyolefin plastics (LDPE, HDPE, PP, etc.) and polystyrene plastics can be collected and used; however, any number of other types of plastics are also contemplated.

Once arriving at the processing facility, the sourced plastic material can be pre-processed such that the shape and size of each piece of individual plastic is reduced so as to be suitable for feeding into the pyrolysis vessel described below. In one embodiment, the received plastic material can be shredded via one or more industrial shredding machines into small ribbons-ideally about 2 to 20 mm in width, 0.1 to 1 mm thick, and 5 to 50 mm in length- or into a powder-ideally about 0.5 up to 5 mm wide. In either instance, the processed plastic material can then be compressed and/or molded to form a series of uniformly shaped and sized ingots having a size of about 5 mm to 30 mm, for example.

Of course, the pre-processing of the plastic is not limited to the use of a shredder and compression equipment, as any number of other devices and methods for manipulating the shape and size of the plastic so as to be suitable for liquification by step 2 of the proposed method are also contemplated. Several nonlimiting examples include, but are not limited to: grinding, extrusion, heating/melting of the plastic, along with dissolving or softening the plastic utilizing organic solvents, ketones, or esters, for example. Additionally, the processed plastic need not be shaped into ingots, but such a step is preferred for ease of storage, transport, and/or measurements of plastic content.

In the preferred embodiment, the output of this step is a plurality of generally uniformly shaped and sized ingots of densified plastic.

Step 2. Liquefaction of Plastic Waste. In this step, the plastic ingots from step 1 can undergo liquefaction to convert them into a liquefied polymer oil.

In one embodiment, the ingots from step 1 can be fed into a kiln or other such pyrolysis vessel and can be mixed with a molecular absorbent material such as zeolite, and a shielding gas such as argon or nitrogen, for example. In this regard, the shielding gas protects the zeolite and plastic ingots from oxidation or combustion, and the resulting mixture can be slowly heated over approximately 4 hours to between 425 degrees Celsius, and 475 degrees. Of course, other absorbent materials, shielding gasses, temperatures and times are also contemplated.

Once the material has reached the set temperature, it can be held at that temperature for at least 30 minutes before being allowed to cool. At this time, the plastic within the vessel vaporizes and the vapors are carried away from the vessel through a series of tubes where they are cooled and condensed into a polymer oil that will be utilized in step 3 below. Wax also results from this cooling process, and the wax and oil mixture are separated by a distillation apparatus.

In one embodiment, the separated wax can be returned to the pyrolysis vessel with the next batch of ingots to be further processed, and remaining gases produced as a byproduct can be used as fuel for the burners of the pyrolysis vessel.

Although described above as achieving liquification utilizing a kiln with specific materials, gases heat and times, this is but one possible way to achieve the desired outcome of this step. As such, other methods for performing this sub step are contemplated such as:

Thermal decomposition of plastics in an oxygen-limited or inert atmosphere; Catalytic conversion via catalysts (e.g., iron chloride, zeolites, or enzyme-based catalysts) in combination with UV light, heat, and radiation; Solvent dissolution of plastics; and/or use of microwave-assisted depolymerization, supercritical fluid treatment, ultrasonic cavitation, or microbial-assisted solubilization.

In one embodiment, the output of this step is a liquefied polymer oil that serves as the primary input for biological digestion at step 3. In one nonlimiting example, the current step can transform about 20 pounds of plastic ingots produced at step 1 into about 15 pounds of polymer oil.

Step 3. Microbial Digestion in a Bioreactor. In this step, the polymer oil from step 2 can be introduced into a bioreactor containing one or more strains of plastic-degrading microorganisms for processing and digestion. The bioreactor can optimize the digestion process through aeration, agitation, temperature control, and vapor recovery mechanisms.

In one embodiment, the oil produced by step 2 can be fed into the tank of a bioreactor, such as an open-air, pressurized, or vacuum-sealed bioreactor, for example. Next, bacteria such as Pseudomonas putida and/or Pseudomonas fluorescens, for example, can be introduced into the tank of the bioreactor over a series of days to weeks.

Although described above with regard to a particular type of bacteria, other types are contemplated. Several nonlimiting examples include, but are not limited to: Pseudomonas putida, Pseudomonas fluorescens, Rhodococcus ruber, Rhodococcus species, other hydrocarbon-degrading bacteria, or fungi (e.g., Aspergillus or Phanerochaete chrysosporium), and/or Synthetically engineered/genetically modified bacteria or fungi, among others, for example.

In either instance, additional nutrients selected from nitrogen sources, protein sources, mineral nutrients, trace elements, growth factors, or combinations thereof can be introduced into the bioreactor tank to boost the bacteria population, and the tank can be continuously agitated by adding more air via a pump. The air and pump operate to emulsify the oil into the nutrient-rich broth the bacteria live in. In one embodiment, emissions from the bioreactor can be routed out through a cooler and compressor, to recapture any oil vapors and return the captured oil vapors to the bioreactor, thus ensuring no oils are lost to evaporation.

As the bacteria within the tank consume and digest the oil, they produce secondary metabolites. As the digestion process continues, these biodegradable metabolites along with the bacteria themselves become heavy and fall to the bottom of the reactor tank forming a thick mass of biological material (e.g., biomass).

Once a predetermined amount of oil has been digested, or once the oil has been broken down to a predetermined level as verified by chemical or colorimetric analysis, the biomass can be harvested. During the harvesting process a worker can stop the agitation of the bioreactor tank which will cause the oil layer to separate from the biomass material. Of course, other methods of separating the oil from the biomass such as agitation or the use of a centrifuge, for example, are also contemplated.

In one embodiment, the output of this step is a liquid suspension of oil-free biomass material having no traceable amounts of plastic. In one nonlimiting example, the current step can transform about 15 pounds polymer oil into about 10 pounds of plastic-free liquid biomass material.

Step 4. Post-Digestion Processing. In this step, the liquid suspension of biomass material from step 3 can be mixed with a gelling agent such as gelatin or agar powder, for example, which will convert the liquid suspension of biomass into a solid puck of plastic-free biomass gel (e.g., “biogel”). The conversion into a gel is advantageous in that it stabilizes the biomass material for handling, storage, and transport, reduces phase separation, and enables controlled downstream use. In particular, gelation renders the biomass physically ingestible and allows for measured, trackable consumption by secondary organisms such as earthworms, insect larvae, aquatic organisms, or livestock as described below.

The gel form further permits controlled release of nutrients, facilitates portioning and metering, and reduces the need to manage free-flowing liquids. In some embodiments, gel formation may be achieved by the addition of a gelling agent and/or by blending the biomass with comminuted organic waste materials, such as food waste, which act as a structural matrix.

In one embodiment, the output of this step is a solid puck of biomass gel. In one nonlimiting example, the current step can transform about 10 pounds of liquid biomass material into about 10-11 pounds of gel having no trace of plastic.

Accordingly, the above noted method provides a novel way to transform environmentally harmful plastic materials into a biomass solution and/or biomass gel which can be utilized for any number of secondary purposes and industries.

For example, the plastic-free biomass solution (output of step 3) or biogel (output of step 4) can introduced as feedstock for decomposer organisms such as earthworms. In this regard, the digestion of the biogel by the earthworms creates castings (e.g., earthworm manure) which, along with the worms themselves, can be composted into a highly nutrient rich precursor that can be used in fertilizer, soil amendments, or soil mixes.

Of course, this is but one possible use, as the resulting material can be consumed by other organisms such as various fungi, insect larvae and the like which can transform the material into biologically valuable outputs, such as fertilizers, soil amendments, and/or biomass for other purposes such as secondary processing in food or industrial applications.

Alternatively, the biomass solution or biogel produced by the above described methodology can be sold directly in soil mixes, dumped in landfills (as it is fully biodegradable), used for other soil filling applications, and/or used for the creation or ceramics, among any number of other uses, for example.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state “means” for performing a specified function or “step” for performing a specified function should not be interpreted as a “means” or “step” clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of converting plastic to biologically degradable materials, said method comprising:
receiving a plastic material;
converting the received plastic material into a polymer oil;
placing the polymer oil into a bioreactor;
introducing a bacteria into the bioreactor containing the polymer oil;
generating a biomass material within the bioreactor; and
harvesting the biomass material from the bioreactor,
wherein a harvested biomass material comprises a biologically degradable plastic-free composition.

2. The method of claim 1, wherein the received plastic includes at least one of polyolefin plastics or polystyrene plastics.

3. The method of claim 2, further comprising:
preprocessing the received plastic.

4. The method of claim 3, wherein said preprocessing comprises:
shredding individual pieces of the received plastic into ribbons.

5. The method of claim 3, wherein said preprocessing comprises:
shredding and compacting individual pieces of the received plastic into a plastic powder.

6. The method of claim 1, wherein the step of converting the received plastic material into a polymer oil includes:
feeding the received plastic material into pyrolysis vessel.

7. The method of claim 6, further comprising:
heating the received plastic material within the pyrolysis vessel to a first temperature for a first period of time.

8. The method of claim 7, further comprising:
capturing vapors from the heated plastic material.

9. The method of claim 8, further comprising:
cooling the captured vapors to create the polymer oil.

10. The method of claim 1, wherein the bioreactor includes at least one of an open-air bioreactor, a pressurized bioreactor, or vacuum-sealed bioreactor.

11. The method of claim 1, wherein the bacteria are configured to consume and digest the polymer oil.

12. The method of claim 1, wherein the harvesting the biomass material from the bioreactor includes the step of separating a remaining oil from the biomass material.
